(19) United States
(12) Patent Application Publication
(10) Pub. No.: US 2026/0176414 A1
(43) Pub. Date: Jun. 25, 2026

(54) METHOD FOR PRODUCING POLYMER AND APPARATUS FOR PRODUCING POLYMER

(71) Applicant: Panasonic Intellectual Property Management Co., Ltd., Osaka (JP)

(72) Inventors: RIHO MORIYAMA, Osaka (JP); TAICHI NAKAMURA, Osaka (JP); YOSHIE TAKAHASHI, Osaka (JP)

(21) Appl. No.: 19/541,221

(22) Filed: Feb. 16, 2026

Related U.S. Application Data
(63) Continuation of application No. PCT/JP2024/039260, filed on Nov. 5, 2024.

(30) Foreign Application Priority Data
Dec. 14, 2023 (JP) 2023-211442

(51) Int. Cl. C08G 61/12; B01J 19/00; B01J 19/06; C08G 61/10

(52) U.S. Cl. CPC C08G 61/122; B01J 19/0013; B01J 19/06; C08G 61/10; B01J 2219/00164; C08G 2261/11; C08G 2261/312; C08G 2261/3221; C08G 2261/41

(57) ABSTRACT

A method for producing a polymer is a method for producing a polymer by a polymerization reaction that occurs in a flow path through which a fluid including three types of raw materials including at least one type of monomer, a ligand, and a metal catalyst flows, the method including: a mixing step of separately feeding one fluid including some of the three types of raw materials and another fluid including remaining one or more of the three types of raw materials into a flow path so as to form, in the flow path, a mixed fluid including the three types of raw materials; and a slug flow formation step of introducing an insoluble fluid that is insoluble in a mixed fluid into a flow path and merging the mixed fluid and the insoluble fluid so as to form a slug flow, in which the slug flow formation step includes controlling the formation of the slug flow such that the mixed fluid and the insoluble fluid are merged within a predetermined time after the mixed fluid is formed.

### TECHNICAL FIELD

The present disclosure relates to a method for producing a polymer and an apparatus for producing a polymer, and specifically relates to a method and an apparatus for producing a polymer by a polymerization reaction.

### BACKGROUND ART

Conventionally, a polymerization reaction of monomers for producing a polymer is performed in a batch manner. In the batch manner, synthesizing a polymer having a narrow distribution of molecular weight is problematic in that it is difficult to control the temperature in the reaction vessel to be uniform and the reactants to be uniformly mixed, and the batch manner is not suitable for mass production.

In recent years, in the field of chemical synthesis, chemical reactions using microvessels called microreactors have been studied. The microreactor is a microvessel including a flow path through which a fluid flows and a feed path that communicates with the flow path and supplies the fluid to the flow path. The fluids including a plurality of raw materials for polymerization reactions supplied through the feed path are merged and mixed in the flow path, and flow, and the polymerization reaction proceeds to synthesize the polymer. A typical flow path diameter of the flow path constituting the microreactor ranges from several tens of μm to several mm.

In the reaction using the microreactor, more accurate flow control, temperature control, and rapid mixing for the reaction solution are achievable, and thus improvement in conversion rate and selectivity is expected as compared with the conventional batch-type reaction, and attention is paid to the reaction using the microreactor as an efficient production method. Examples of the method for synthesizing a polymer using a microreactor include a production method disclosed in Patent Literature 1.

### CITATION LIST

### Patent Literature

PTL 1: Unexamined Japanese Patent Publication No. 2015-127425

### SUMMARY OF THE INVENTION

In the polymerization reaction of the monomer, there may be particles that are not dissolved in the solvent. In this case, for example, in the production method using the microreactor disclosed in Patent Literature 1, particles that are not dissolved in the solvent adhere to and deposit on the inner wall surface of the flow path. Therefore, the process of producing the polymer is problematic in that insoluble particles adhere to the inner wall surface of the flow path.

An object of the present disclosure is to provide a method and an apparatus for producing a polymer capable of suppressing adhesion of insoluble particles to an inner wall surface of a flow path in a polymer production process.

A method for producing a polymer according to one aspect of the present disclosure is a method for producing a polymer by a polymerization reaction that occurs in a flow path through which a fluid including three types of raw materials including at least one type of monomer, a ligand, and a metal catalyst flows, the method including: a mixing step of separately feeding one fluid including some of the three types of raw materials and another fluid including remaining one or more of the three types of raw materials into a flow path so as to form, in the flow path, a mixed fluid including the three types of raw materials; and a slug flow formation step of introducing an insoluble fluid that is insoluble in a mixed fluid into a flow path and merging the mixed fluid and the insoluble fluid so as to form a slug flow, in which the slug flow formation step includes controlling formation of the slug flow such that the mixed fluid and the insoluble fluid are merged within a predetermined time after the mixed fluid is formed.

In addition, an apparatus for producing a polymer according to one aspect of the present disclosure is an apparatus for producing a polymer by a polymerization reaction that occurs in a flow path through which a fluid including three types of raw materials including at least one type of monomer, a ligand, and a metal catalyst flows, the apparatus including: a flow path; a liquid feeder configured to separately feed one fluid including some of the three types of raw materials, and another fluid including remaining one or more of the three types of raw materials, to the flow path; a mixer configured to be disposed on an upstream side in the flow path and form a mixed fluid including the three types of raw materials fed from the liquid feeder; and a slug flow former configured to be disposed downstream of the mixer in the flow path; and an insoluble fluid introduction unit configured to introduce an insoluble fluid that is insoluble in the mixed fluid into the slug flow former; and a controller, in which the slug flow former merges the mixed fluid and the insoluble fluid so as to form a slug flow, and the controller controls the flow rate of the mixed fluid to cause the mixed fluid to reach the slug flow former within a predetermined time from the mixer.

The term “slug flow” as used herein refers to a flow in which two fluids mutually immiscible flow alternately along a flow path. For example, in the present disclosure, when the “mixed fluid” of the first fluid and the “insoluble fluid” of the second fluid simultaneously flow in the flow path, the mixed fluid and the insoluble fluid are separated from each other by the phase interface, and the “mixed fluid cell” and the “insoluble fluid cell” alternately disposed are formed. In the slug flow, a circulation flow is generated in the mixed fluid cell, and a local stirring action is generated by the circulation flow. The “mixed fluid cell” and the “insoluble fluid cell” referred to herein are a columnar mixed fluid segment and an insoluble fluid segment alternately flowing in the flow path, respectively.

The method for producing a polymer or the apparatus for producing a polymer according to one aspect of the present disclosure can suppress adhesion of insoluble particles to the inner wall surface of the flow path in the process of producing a polymer.

### BRIEF DESCRIPTION OF THE DRAWINGS

FIG. 1 is a schematic view illustrating one example of a configuration of an apparatus for producing a polymer according to an exemplary embodiment of the present disclosure.

FIG. 2 is a conceptual view illustrating a slug flow in a flow path of the apparatus for producing a polymer of FIG. 1.

FIG. 3 is a flowchart showing an example of a polymer production process using the apparatus for producing a polymer according to an exemplary embodiment of the present disclosure.

FIG. 4 is a table showing measurement results of flow path blockage in polymer production processes performed in Examples 1 and 2 and Comparative Example 1.

### DESCRIPTION OF EMBODIMENT

One aspect of the present disclosure provides a method for producing a polymer by a polymerization reaction that occurs in a flow path through which a fluid including three types of raw materials including at least one type of monomer, a ligand, and a metal catalyst flows, the method including: a mixing step of separately feeding one fluid including some of the three types of raw materials and another fluid including remaining one or more of the three types of raw materials into a flow path so as to form, in the flow path, a mixed fluid including the three types of raw materials; and a slug flow formation step of introducing an insoluble fluid that is insoluble in a mixed fluid into a flow path and merging the mixed fluid and the insoluble fluid so as to form a slug flow, in which the slug flow formation step includes controlling the formation of the slug flow such that the mixed fluid and the insoluble fluid are merged within a predetermined time after the mixed fluid is formed.

This aspect can suppress adhesion of insoluble particles to the inner wall of the flow path in the process of producing a polymer.

A second aspect of the present disclosure provides the method for producing a polymer according to the first aspect, in which the controlling the formation of the slug flow includes adjusting a flow rate of feeding at least one of the one fluid or the other fluid into the flow path.

A third aspect of the present disclosure provides the method according to the first or second aspect, in which the slug flow formation step includes adjusting a flow rate for introducing an insoluble fluid into the flow path.

A fourth aspect of the present disclosure provides the method according to any one of the first to third aspects, the method further including a thermal reaction step of heating a slug flow.

A fifth aspect of the present disclosure provides the method according to any one of the first to fourth aspects, in which a metal catalyst has a chemical formula of M(cod)₂, where M is a metal including at least one of nickel, platinum, and palladium.

A sixth aspect of the present disclosure provides the method according to any one of the first to fifth aspects, in which the inner wall of the flow path is composed of a material having low polarity.

A seventh aspect of the present disclosure provides the method according to the sixth aspect, in which the three types of raw materials are dissolved or dispersed in a polar solvent.

An eighth aspect of the present disclosure provides the method according to the sixth aspect, in which the insoluble fluid is composed of a non-polar solvent.

A ninth aspect of the present disclosure provides the method according to any one of the first to seventh aspects, in which the insoluble fluid is composed of a gas.

A tenth aspect of the present disclosure provides an apparatus for producing a polymer by a polymerization reaction that occurs in a flow path through which a fluid including three types of raw materials including at least one type of monomer, a ligand, and a metal catalyst flows, the apparatus including: a flow path; a liquid feeder configured to separately feed one fluid including some of the three types of raw materials, and another fluid including remaining one or more of the three types of raw materials, to the flow path; a mixer configured to be disposed on an upstream side in the flow path and form a mixed fluid including the three types of raw materials fed from the liquid feeder; a slug flow former configured to be disposed downstream of the mixer in the flow path; an insoluble fluid introduction unit configured to introduce an insoluble fluid that is insoluble in the mixed fluid into the slug flow former; and a controller, in which the slug flow former merges the mixed fluid and the insoluble fluid so as to form a slug flow, and the controller controls the flow rate of the mixed fluid to cause the mixed fluid to reach the slug flow former within a predetermined time from the mixer.

An eleventh aspect of the present disclosure provides the apparatus according to the tenth aspect, in which the controller is configured to adjust a flow rate at which at least one of the one fluid or the other fluid is fed into the flow path.

A twelfth aspect of the present disclosure provides the apparatus according to the tenth or eleventh aspect, in which the controller is configured to adjust a flow rate at which the insoluble fluid is introduced into the slug flow former.

A thirteenth aspect of the present disclosure provides the apparatus according to any one of the tenth to twelfth aspects, the apparatus further including a heater disposed downstream of the slug flow former in the flow path.

A fourteenth aspect of the present disclosure provides the apparatus according to any one of the tenth to thirteenth aspects, in which the inner wall of the flow path is composed of a material having low polarity.

Note that by appropriately combining selected one of exemplary embodiments among the various exemplary embodiments described above, the effects of the respective exemplary embodiments can be achieved.

Hereinafter, exemplary embodiments will be described in detail with appropriate reference to the drawings. However, unnecessarily detailed description may be omitted. For example, detailed descriptions of already well-known matters and duplicated descriptions of substantially the same configuration may be omitted. This is to avoid an unnecessarily redundancy in the following description and to facilitate understanding by a person skilled in the art.

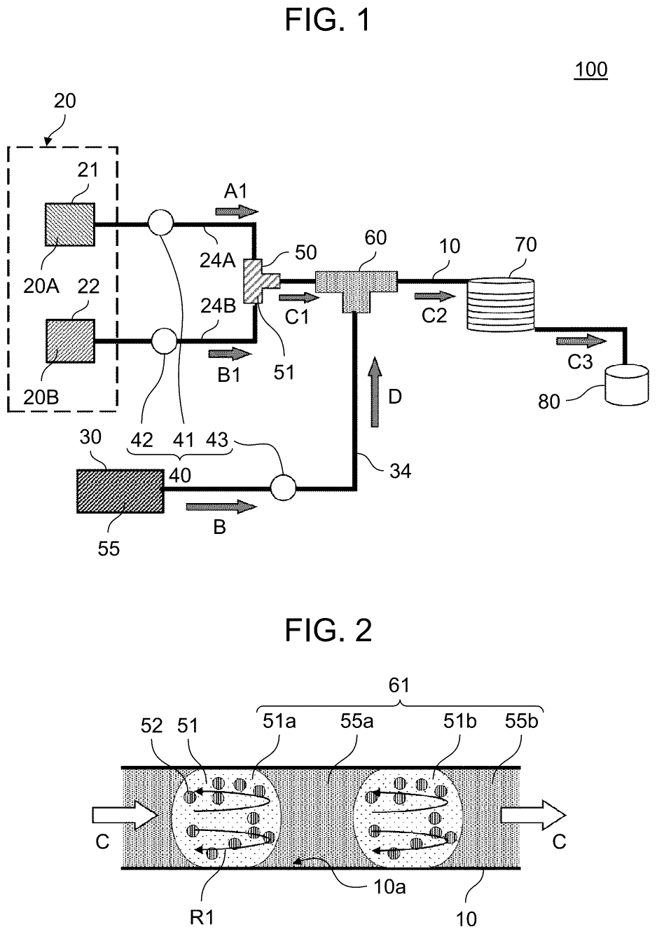

The method for producing a polymer and the apparatus for producing a polymer according to an exemplary embodiment of the present disclosure will be described with reference to FIGS. 1 to 3. The accompanying drawings and the following description are provided for those skilled in the art to fully understand the present disclosure, and are not intended to limit the subject matter described in the claims in any way. Furthermore, in each of the drawings, elements are illustrated exaggeratedly in order to facilitate the description. In the drawings, substantially the same members are denoted by the same reference marks.

### (Polymer Polymerization Reaction and Raw Materials Thereof)

The method for producing a polymer and the apparatus for producing a polymer of the present disclosure are used for producing a polymer by a polymerization reaction of a monomer. Examples of the polymer to be generated include, but are not limited to, a conductive polymer such as polyphenylene or polythiophene, or a polymer having a functional group at a terminal and used for an ion exchange resin or the like. In addition, in an exemplary embodiment according to the present disclosure, three types of raw materials of at least one type of monomer, a ligand, and a metal catalyst are used in the polymerization reaction for producing these polymers.

The monomer as a raw material of the polymerization reaction is not particularly limited as long as a functional group such as a halogen group is at the terminal group according to the coupling reaction to be used, and can be appropriately selected according to the purpose. Examples thereof include phenylene, thiophene, and fluorene having a functional group according to a purpose, such as an alkyl group, an allyl group, an acyl group, a benzoyl group, a nitro group, a sulfo group, and an amino group, and hydrocarbons and aromatic compounds including alkyl, sulfone, ether, fluoride, and the like having a functional group. These monomers may be used singly or in combination of two or more thereof.

The ligand as a raw material of the polymerization reaction is not limited thereto, and for example, bipyridine, triphenylphosphine, or the like can be used. These ligands can promote the coupling reaction of the monomer by forming a complex with the metal ion of the metal catalyst in the polymerization reaction of the monomer.

The metal catalyst as a raw material of the polymerization reaction has a chemical formula of M(cod)₂, where M is preferably a metal including at least one of nickel (Ni), platinum (Pt), and palladium (Pd).

In the polymerization reaction of the monomer, three types of raw materials of the monomer, the ligand, and the metal catalyst are dissolved or dispersed in a solvent and mixed. At this time, the complex formed by the ligand and the metal of the metal catalyst promotes the progress of the polymerization reaction, and generates a by-product that is not dissolved in the solvent, for example, a chloride, a bromide, or an iodide of the metal. As the polymerization reaction proceeds, by-products that are not dissolved in the solvent as described above are generated, and the particles grow and become insoluble particles. The insoluble particles adhere to and accumulate on the inner wall surface of the flow path, thereby causing flow path blockage. The method for producing a polymer and the apparatus for producing a polymer of the present disclosure can suppress adhesion of insoluble particles generated in the process of producing a polymer to the inner wall surface of the flow path, and can improve polymer productivity. Hereinafter, a configuration of apparatus 100 for producing a polymer according to an exemplary embodiment of the present disclosure will be described with reference to FIG. 1.

### Exemplary Embodiment

### <<Configuration of Apparatus for Producing a Polymer>>

FIG. 1 is a schematic view illustrating one example of a configuration of apparatus 100 for producing a polymer according to an exemplary embodiment of the present disclosure. Apparatus 100 for producing a polymer illustrated in FIG. 1 includes flow path 10, liquid feeder 20, insoluble fluid introduction unit 30, controller 40, mixer 50, slug flow former 60, heater 70, and recovery unit 80. Apparatus 100 for producing a polymer can be used to produce a polymer by a polymerization reaction of monomers proceeding in flow path 10.

Liquid feeder 20 of apparatus 100 for producing a polymer illustrated in FIG. 1 includes fluid feeders 21, 22, and is used to feed raw materials that generate a polymer by a polymerization reaction of monomers into flow path 10. Fluid feeders 21, 22 include, for example, a reservoir and a liquid feeding equipment (not illustrated), store a solution obtained by dissolving or dispersing raw materials for producing a polymer in a solvent in the reservoir, and feed the solution in the reservoir by the liquid feeding equipment. The liquid feeding equipment can be composed of, for example, a syringe pump, a plunger pump, a diaphragm pump, a tube pump, a Mohno pump, a piezo pump, or the like (not illustrated).

In the present exemplary embodiment, as illustrated in the drawing, liquid feeder 20 is configured to divide a fluid including three types of raw materials of a monomer, a ligand, and a metal catalyst for producing a polymer into first fluid 20A and second fluid 20B, and to separately feed the fluids into flow path 10 through pipes 24A, 24B by fluid feeder 21 and fluid feeder 22, respectively. Herein, first fluid 20A includes some types of raw materials among the three types of raw materials, and in the present exemplary embodiment, for example, can include any two types among a monomer, a ligand, and a metal catalyst. Second fluid 20B includes other types of raw materials among the three types of raw materials, and in the present exemplary embodiment, for example, can include another one type of a monomer, a ligand, and a metal catalyst different from those of first fluid 20A.

FIG. 1 illustrates that liquid feeder 20 divides the solutions of the three types of raw materials for the polymerization reaction into two fluids 20A, 20B and separately feeds them into flow path 10, but the present disclosure is not limited thereto. Liquid feeder 20 can include any number of fluid feeders. For example, three fluid feeders are provided and configured such that three types of raw materials are divided into each fluid including one type of the raw material and separately fed into flow path 10. In addition, liquid feeder 20 is not limited to the type of the fluid to be fed into the flow path. For example, depending on the application, in addition to the three types of raw materials, liquid feeder 20 can be configured such that another fluid is fed into flow path 10 together with the three types of raw materials or from another fluid feeder.

As described above, dividing the raw materials used for the polymerization reaction of the polymer into two or more fluids and feeding the fluids separately into the flow path can suppress the generation of insoluble particles due to the progress of the polymerization reaction before the raw materials are fed into the flow path.

As illustrated in FIG. 1, apparatus 100 for producing a polymer includes controller 40, and in the present exemplary embodiment, controller 40 can be composed of, for example, flow rate adjustment devices 41, 42, 43 respectively disposed in pipes 24A, 24B of liquid feeder 20 and pipe 34 of insoluble fluid introduction unit 30 described later. Flow rate adjustment devices 41, 42, 43 can respectively adjust the flow rates of first fluid 20A, second fluid 20B, and insoluble fluid 55 fed into flow path 10. Controller 40 adjusts the flow rate of the fluid fed into flow path 10, thereby allowing the formation of the slug flow to be controlled in flow path 10. Controller 40 will be described in detail later.

First fluid 20A and second fluid 20B are fed into flow path 10 through pipes 24A, 24B in directions A1, B1, respectively.

Flow path 10 extends between mixer 50 at the upstream end and recovery unit 80 at the downstream end, and can be constituted by, for example, a microgroove. In flow path 10, solutions of three types of raw materials of a monomer, a ligand, and a metal catalyst are mixed and flow, and a polymerization reaction of the monomer proceeds to generate a polymer. Flow path 10 can be configured to have a flow path diameter in a range, for example, from 250 μm to 6 mm inclusive. In addition, the present disclosure is not limited to the cross-sectional shape of flow path 10. Flow path 10 can have, for example, a cross-sectional shape and/or a flow path diameter different from those of pipes 24A, 24B of liquid feeder 20 or pipe 34 of insoluble fluid introduction unit 30 described later. Further, flow path 10 can have a variable flow path diameter between mixer 50 at the upstream end and recovery unit 80 at the downstream end.

The inner wall of flow path 10 can be composed of a material having low polarity. Examples of the material constituting the inner wall of flow path 10 include fluorine-based resins such as polytetrafluoroethylene (PTFE) and tetrafluoroethylene-perfluoroalkyl vinyl ether copolymer (PFA), and olefin-based resins such as polyethylene (PE) and polypropylene (PP), and one of these resins or a combination of two or more thereof can be used. In addition, not limited to the inner wall, flow path 10 may be configured using a material having low polarity as a main material as a whole.

mixer 50 is disposed on the upstream side of flow path 10 and can be configured as a part of flow path 10, and can be composed of, for example, a flow path connecting member. First fluid 20A and second fluid 20B fed from liquid feeder 20 are mixed in mixer 50 to form mixed fluid 51. At this time, a polymerization reaction of the monomer starts and proceeds.

Mixed fluid 51 formed in mixer 50 flows downstream along flow path 10 and reaches slug flow former 60. slug flow former 60 is connected to insoluble fluid introduction unit 30.

Insoluble fluid introduction unit 30 can introduce insoluble fluid 55 for forming a slug flow into slug flow former 60. In the present specification, the insoluble fluid includes a liquid or a gas that is insoluble in the mixed fluid formed in the mixer. Insoluble fluid introduction unit 30 includes, for example, a reservoir and a liquid feeding equipment (not illustrated), stores a liquid or gas insoluble in the mixed fluid in the reservoir, and feeds the insoluble fluid in the reservoir by the feeding equipment. The feeding equipment is not limited thereto, but can be composed of, for example, a syringe pump, a plunger pump, a diaphragm pump, a tube pump, a Mohno pump, a piezo pump, or the like (not illustrated).

Insoluble fluid 55 in insoluble fluid introduction unit 30 can be pumped to slug flow former 60 through pipe 34, for example, by the pressure of pump 43 disposed in pipe 34. Pump 43 can be used as a flow rate adjusting means when an insoluble fluid is fed, and the insoluble fluid can be introduced into slug flow former 60 at a desired flow rate (flow velocity).

slug flow former 60 is configured to merge mixed fluid 51 fed from mixer 50 and insoluble fluid 55 introduced by insoluble fluid introduction unit 30 to form a slug flow. slug flow former 60 can be configured as a part of flow path 10 and can be composed of, for example, a flow path connecting member.

Insoluble fluid introduction unit 30 introduces insoluble fluid 55 into slug flow former 60. Introduced insoluble fluid 55 merges with mixed fluid 51 in slug flow former 60 to form a slug flow in which the mixed fluid cells and the insoluble fluid cells flow in alternating sequence. Insoluble fluid introduction unit 30 can be disposed so as to introduce insoluble fluid 55 into slug flow former 60 from a direction intersecting flow direction C1 of mixed fluid 51. In the present exemplary embodiment, as illustrated in FIG. 1, insoluble fluid introduction unit 30 introduces insoluble fluid 55 into slug flow former 60 from direction D substantially orthogonal to flow direction C1 of mixed fluid 51. Formation of the slug flow makes it possible to suppress adhesion and deposition of insoluble particles generated as the polymerization reaction proceeds on the inner wall surface of flow path 10. This will be described in detail later.

Slug flow formed in slug flow former 60 flows further downstream along flow path 10 in C2 direction from slug flow former 60, and is fed to heater 70 on the downstream side.

Heater 70 can be configured as a part of flow path 10, and can have a length in a range, for example, from 10 cm to 20 m inclusive. In heater 70, for example, a thermostatic bath or the like can be provided to heat the slug flow in the flow path. In the present exemplary embodiment, as illustrated in FIG. 1, heater 70 is composed of a flow path formed in a spiral shape (coiled shape), which can improve heating efficiency. The heating temperature of heater 70 can be set according to the raw materials used for the polymerization reaction in the flow path.

Heating the fluid in which the slug flow is formed in the flow path of heater 70 can promote the polymerization reaction of the monomer in the flow path to improve the production rate of the polymer. In addition, heating the fluid in which the slug flow is formed to promote the polymerization reaction can suppress the particle growth of by-products of the polymerization reaction and prevent the occurrence of flow path blockage due to deposition of insoluble particles adhering to the inner wall surface of the flow path.

The fluid that has passed through heater 70 flows further downstream in C3 direction along flow path 10 and is introduced into recovery unit 80.

Recovery unit 80 is disposed at the downstream end of flow path 10, and can be constituted by, for example, a cylindrical container having a predetermined height as illustrated in the drawing. In recovery unit 80, for example, the fluid in flow path 10 can be separated by a difference in specific gravity to recover the polymer as a product.

### <Formation of Slug Flow>

The formation of a slug flow in flow path 10 of apparatus 100 for producing a polymer will be described with reference to FIG. 2. FIG. 2 is a conceptual view illustrating a slug flow in flow path 10 of apparatus 100 for producing a polymer of FIG. 1.

As illustrated in FIG. 2, slug flow 61 formed in slug flow former 60 and flowing in flow path 10 includes fluid cells of a mixed fluid (hereinafter, referred to as a “mixed fluid cell”) 51a, 51b and fluid cells of an insoluble fluid (hereinafter, referred to as an “insoluble fluid cell”) 55a, 55b. Mixed fluid cells 51a, 51b and the insoluble fluid cells 55a, 55b are alternately disposed along flow path 10 and flow in downstream direction C.

In slug flow 61, circulation flow R1 is generated in mixed fluid cells 51a, 51b, and a local stirring action is generated by circulation flow R1. This promotes liquid mixing in mixed fluid cells 51a, 51b.

In the present exemplary embodiment, in mixer 50, three types of raw materials of a monomer, a ligand, and a metal catalyst are mixed, and in mixed fluid 51, a polymerization reaction of the monomer proceeds and a by-product is generated.

Aggregation of the precipitated polymer particles on the surface of the by-product causes insoluble particles 52 that are not dissolved in the solvent of mixed fluid 51 to be generated.

In slug flow former 60, slug flow 61 is generated, and the stirring action of circulation flow R1 generated in mixed fluid cells 51a, 51b makes it possible to suppress the adhesion of insoluble particles 52 in mixed fluid 51 to inner wall surface 10a of flow path 10 and the deposition of insoluble particles 52 on inner wall surface 10a. This makes it possible to suppress the occurrence of flow path blockage in apparatus 100 for producing a polymer during the polymerization reaction.

In the present exemplary embodiment, after mixed fluid 51 is formed in mixer 50, controller 40 can perform control so as to cause mixed fluid 51 to reach slug flow former 60 within a predetermined time and to merge with insoluble fluid 55. Preferably, mixed fluid 51 is controlled to reach slug flow former 60 from mixer 50 in a time longer than 0 seconds and shorter than 5 seconds.

Until mixed fluid 51 reaches slug flow former 60 from mixer 50, the polymerization reaction of the monomer proceeds, and the grain growth of the by-product occurs. Control of merging mixed fluid 51 and insoluble fluid 55 within a predetermined time can form a slug flow before insoluble particles 52 generated by the grain growth of the by-product adhere to inner wall surface 10a of flow path 10 and start to be deposited. In the formed slug flow, stirring by circulation flow R1 in mixed fluid cells 51a, 51b suppresses the particle growth of the by-product and the adhesion and deposition of insoluble particles 52 on inner wall surface 10a of flow path 10, and thus the occurrence of flow path blockage can be prevented and the polymerization reaction of the monomer can proceed.

In the present exemplary embodiment, as illustrated in FIG. 1, controller 40 includes flow rate adjustment devices 41, 42, 43. The flow rate at which first fluid 20A and second fluid 20B are fed into flow path 10 is adjusted by flow rate adjustment devices 41, 42 disposed in pipes 24A, 24B of liquid feeder 20, respectively, whereby mixed fluid 51 reaches slug flow former 60 within a predetermined time after being formed, and can merge with insoluble fluid 55. In addition, the flow rate ratio between mixed fluid 51 and insoluble fluid 55 in flow path 10 can be set to a predetermined value by adjusting the flow rate at which insoluble fluid 55 is fed into flow path 10 by the flow rate adjustment device 43 disposed in pipe 34 of insoluble fluid introduction unit 30. As a result, stable slug flow 61 flows in flow path 10, and insoluble particles 52 are suppressed from adhering to or depositing on inner wall surface 10a, and occurrence of flow path blockage can be effectively prevented.

The present disclosure is not limited to the configuration of controller 40. Controller 40 can also include other configurations for controlling the formation of the slug flow. For example, controller 40 can be configured to adjust the configuration of the flow path between mixer 50 and slug flow former 60. The present disclosure is not limited to the configuration of the flow rate adjustment device. The flow rate adjustment device can be composed of, for example, any one of a pump, a flow meter, a proportional control feed valve, and the like (not illustrated), or any combination thereof. In addition, the flow rate adjustment device is not limited to being disposed in the pipe connected to the flow path. For example, a flow rate adjustment device can be disposed in flow path 10 to adjust the flow rate of the mixed fluid.

In the present exemplary embodiment, the solvent for dissolving or dispersing the three types of raw materials of the polymerization reaction of the monomer is preferably a polar solvent. Examples of the polar solvent include, but are not limited to, dimethylsulfoxide, N,N-dimethylacetamide, tetrahydrofuran, ethanol, and water, and among these, dimethylsulfoxide, N,N-dimethylacetamide, and tetrahydrofuran are preferably used.

In the present exemplary embodiment, insoluble fluid 55 may be a liquid or a gas. In the case of a liquid, a non-polar solvent can be included. The non-polar solvent is not limited thereto, but for example, a linear saturated hydrocarbon, an aromatic hydrocarbon, a silicone oil, or the like is preferably used. In the case of a gas, for example, argon gas or nitrogen gas is preferably used.

In the present exemplary embodiment, as described above, the inner wall of flow path 10 can be composed of a material having low polarity. When insoluble fluid 55 is composed of a non-polar solvent, as illustrated in FIG. 2, in flow path 10, insoluble fluid cells 55a, 55b have higher affinity for inner wall surface 10a of flow path 10 than mixed fluid cells 51a, 51b. Therefore, in slug flow 61, the contact area between mixed fluid cells 51a, 51b and inner wall surface 10a is reduced. As a result, it is possible to further suppress adhesion and deposition of insoluble particles 52 on inner wall surface 10a of flow path 10.

### <Polymer Production Process>

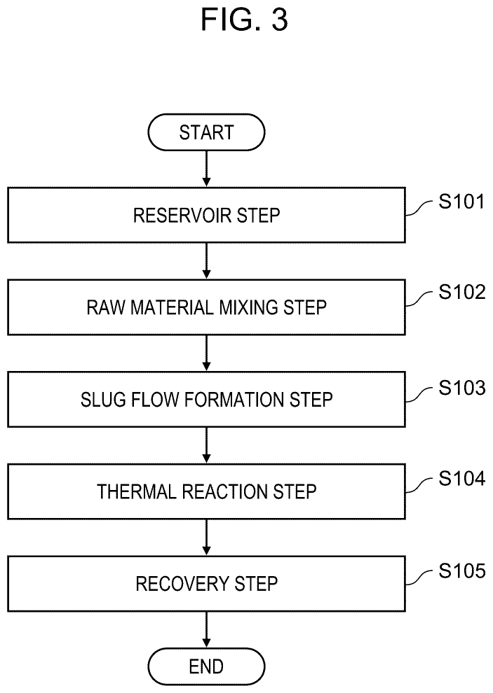

A polymer production process will be described with reference to FIG. 3. FIG. 3 is a flowchart showing an example of a polymer production process using apparatus 100 for producing a polymer according to an exemplary embodiment of the present disclosure.

As shown in FIG. 3, the polymer production process can include the steps of step S101 to step S105. Each step will be described below. Hereinafter, a polymer production process by a polymerization reaction of two monomers including monomer 1 and monomer 2 will be described together with reference to FIG. 1.

In reservoir step S101, for example, the first fluid in which monomer 1, monomer 2, and the ligand are dissolved in the solvent is stored in the reservoir of fluid feeder 21 of liquid feeder 20, and the second fluid in which the metal catalyst is dissolved or dispersed in the solvent is stored in the reservoir of fluid feeder 22 of liquid feeder 20. Insoluble fluid 55 is stored in the reservoir of insoluble fluid introduction unit 30. The configurations of the first fluid and the second fluid are not limited thereto, and may be divided into one fluid including some types of raw materials among three types of raw materials of a monomer, a ligand, and a metal catalyst and the other fluid including other types of raw materials.

In raw material mix step S102, the liquid feeding equipment of fluid feeders 21, 22 of liquid feeder 20 is operated to feed the first fluid and the second fluid to mixer 50. In mixer 50, the three types of raw materials dissolved or dispersed in the solvent are mixed to form mixed fluid 51. At this time, the polymerization reaction of the monomer starts to proceed.

Then, in slug flow formation step S103, the feeding equipment of insoluble fluid introduction unit 30 is operated to introduce insoluble fluid 55 into slug flow former 60. In slug flow former 60, mixed fluid 51 from mixer 50 and insoluble fluid 55 introduced from insoluble fluid introduction unit 30 merge to form slug flow 61.

In addition, at this time, controller 40 can control mixed fluid 51 to reach slug flow former 60 within a predetermined time from mixer 50 and to merge with insoluble fluid 55 by adjusting the flow rate at which the first fluid and the second fluid are fed into flow path 10. As a result, slug flow 61 can be formed before insoluble particles 52 generated by the polymerization reaction of the monomer adhere to inner wall surface 10a of flow path 10 and start to be deposited. Further, controller 40 can set the flow rate ratio between mixed fluid 51 and insoluble fluid 55 in flow path 10 to a predetermined value by adjusting the flow rate at which insoluble fluid 55 is fed into flow path 10. As a result, stable slug flow 61 can flow in flow path 10.

Then, in thermal reaction step S104, slug flow 61 formed in slug flow former 60 and flowing in flow path 10 is passed through heater 70 and heated to promote the polymerization reaction of the monomer. At this time, stirring by the circulation flow in the mixed fluid cell can suppress the particle growth of the by-product of the polymerization reaction and suppress the insoluble particles from adhering to and depositing on the inner wall surface of the flow path, thereby preventing the occurrence of flow path blockage.

Finally, in recovery step S105, the fluid in flow path 10 is separated to recover the polymer of the product.

A polymer can be produced by the above steps. The polymer production process is merely an example, and the production of the polymer is not limited to the above process.

According to the apparatus for producing a polymer and the polymer production process of the present exemplary embodiment as described above, in the polymer production process, the insoluble particles can be suppressed from adhering to the inner wall surface of the flow path, and the productivity of the polymer can be improved.

### EXAMPLES AND COMPARATIVE EXAMPLES

In Examples 1 and 2 and Comparative Example 1, a polymer was produced using raw materials of one type of monomer, a ligand, and a metal catalyst. Hereinafter, Examples 1 and 2 and Comparative Example 1 will be described.

### <Apparatus for Producing a Polymer>

The polymer production process shown in FIG. 3 was performed using apparatus 100 for producing a polymer illustrated in FIG. 1. In apparatus 100 for producing a polymer, the flow path diameters in mixer 50 and slug flow former 60 were set to 1 mm, and the flow path diameters of the other flow paths were set to 2 mm. In addition, in Examples 1 and 2, slug flow former 60 was connected to a flow path position about 6.5 cm away from mixer 50. In addition, the flow rate adjustment device of controller 40 was set such that the mixed fluid reached slug flow former 60 from mixer 50 in about 0.3 seconds. At this time, the flow rate of the mixed fluid from the mixer was about 4.0 ml/min. The heating temperature of heater 70 was set to 80° C.

### Example 1

In Example 1, 2,5-dichloropyridine was used as a raw material monomer, bipyridine was used as a ligand, and Ni (cod)₂ was used as a metal catalyst. In addition, three types of raw materials were dissolved or dispersed using N,N-dimethylacetamide as a solvent. As the insoluble fluid, Ar gas was used.

### Example 2

Example 2 is the same as Example 1 except that p-dichlorobenzene was used as a raw material monomer and triphenylphosphine was used as a ligand.

### Comparative Example 1

Comparative Example 1 is the same as Example 1 except that in apparatus 100 for producing a polymer of FIG. 1, insoluble fluid introduction unit 30 and slug flow former 60 are not connected to flow path 10. At this time, apparatus 100 for producing a polymer includes flow path 10, liquid feeder 20, controller 40, mixer 50, heater 70, and recovery unit 80.

### (Evaluation of Flow Path Blockage in Examples and Comparative Example)

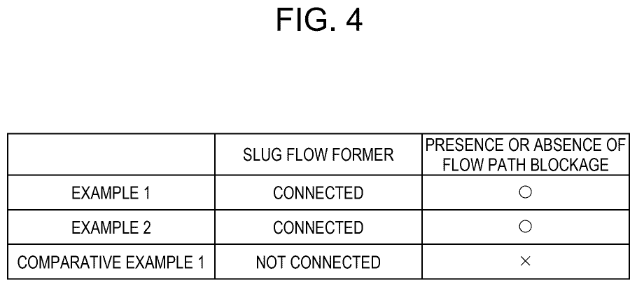

With reference to FIG. 4, measurement of flow path blockage in the polymer production process of Examples 1 and 2 and Comparative Example will be described. FIG. 4 is a table showing measurement results of flow path blockage in polymer production processes performed in Examples 1 and 2 and Comparative Example 1.

The occurrence of flow path blockage was evaluated in the polymer production process of Examples 1 and 2 and Comparative Example. As a method for evaluating the flow path blockage, the pressure in the flow path was measured at the flow path position on the upstream side of mixer 50 using a pressure gauge (FC-PSU-1000, manufactured by DFC Co., Ltd.). When an increase in pressure was observed, it was determined that the insoluble particles adhered to the inner wall surface of the flow path and the flow path was blocked due to deposition, and when an increase in pressure was not observed, it was determined that the flow path was not blocked. In the table of FIG. 4, “absence of flow path blockage” is indicated by ∘, and “presence of flow path blockage” is indicated by ×.

As shown in the table of FIG. 4, in Examples 1 and 2, an increase in pressure was not observed on the downstream side of slug flow former 60. At this time, since the mixed fluid reached the slug flow former 60 from mixer 50 in about 0.3 seconds, the mixed fluid merged with insoluble fluid 55 to form a slug flow before the insoluble particles generated by the polymerization reaction of the monomer adhered to the inner wall surface of the flow path and started to be deposited. As a result, it has been found that in the mixed fluid cell of the slug flow, the adhesion and deposition of insoluble particles on the inner wall surface of the flow path were suppressed by stirring with the circulation flow, and the polymerization reaction of the monomer proceeded without causing flow path blockage.

In contrast, in Comparative Example 1, in apparatus 100 for producing a polymer to which slug flow former 60 was not connected, an increase in pressure was observed on the downstream side of mixer 50. At this time, it has been found that the polymerization reaction of the monomer was started in mixer 5, and as the polymerization reaction proceeded, insoluble particles generated by the particle growth of the by-product adhered to and deposited on the inner wall surface of the flow path, thereby causing flow path blockage.

As described above, the accompanying drawings and the detailed description have been provided to describe the exemplary embodiment of the technique in the present disclosure. Thus, components described in the accompanying drawings and the detailed description may include not only components essential for solving the problem, but also components non-essential for solving the problem to describe the above techniques. For this reason, it should not be immediately recognized that these non-essential components are essential just because these non-essential components are described in the accompanying drawings and the detailed description.

Although the present disclosure has been fully described in connection with a preferred exemplary embodiment with reference to the accompanying drawings, various modifications can be made within the scope of the claims. Such modifications and exemplary embodiments obtained by appropriately combining technical units disclosed in different exemplary embodiments are also included in the technical scope of the present disclosure.

### INDUSTRIAL APPLICABILITY

The present disclosure is applicable to the production of polymers. The present disclosure is applicable to, for example, production of a polymer using a microreactor.

### REFERENCE MARKS IN THE DRAWINGS

10 flow path
20 liquid feeder
21, 22 fluid feeder
30 insoluble fluid introduction unit
40 controller
41, 42, 43 flow rate adjustment device
24A, 24B, 34 pipe
50 mixer
51 mixed fluid
52 insoluble particle
55 insoluble fluid
60 slug flow former
61 slug flow
70 heater
80 recovery unit
100 apparatus for producing a polymer

1. A method for producing a polymer by a polymerization reaction that occurs in a flow path through which a fluid including three types of raw materials including at least one type of monomer, a ligand, and a metal catalyst flows, the method comprising:
a mixing step of separately feeding one fluid including some of the three types of raw materials and another fluid including remaining one or more of the three types of raw materials into the flow path so as to form, in the flow path, a mixed fluid including the three types of raw materials; and
a slug flow formation step of introducing an insoluble fluid that is insoluble in the mixed fluid into the flow path and merging the mixed fluid and the insoluble fluid so as to form a slug flow,
wherein the slug flow formation step includes controlling formation of the slug flow such that the mixed fluid and the insoluble fluid are merged within a predetermined time after the mixed fluid is formed.

2. The method according to claim 1, wherein the controlling formation of the slug flow includes adjusting a flow rate of feeding at least one of the one fluid or the other fluid into the flow path.

3. The method according to claim 1, wherein the slug flow formation step includes adjusting a flow rate for introducing the insoluble fluid into the flow path.

4. The method according to claim 1, further comprising a thermal reaction step of heating the slug flow.

5. The method according to claim 1, wherein the metal catalyst has a chemical formula of M(cod)₂
where M is a metal including at least one of nickel, platinum, and palladium.

6. The method according to claim 1, wherein an inner wall of the flow path is composed of a material having low polarity.

7. The method according to claim 6, wherein the three types of raw materials are dissolved or dispersed in a polar solvent.

8. The method according to claim 6, wherein the insoluble fluid is composed of a non-polar solvent.

9. The method according to claim 1, wherein the insoluble fluid is composed of a gas.

10. An apparatus for producing a polymer by a polymerization reaction that occurs in a flow path through which a fluid including three types of raw materials including at least one type of monomer, a ligand, and a metal catalyst flows, the apparatus comprising:
a flow path;
a liquid feeder configured to separately feed one fluid including some of the three types of raw materials and another fluid including remaining one or more of the three types of raw materials, to the flow path;
a mixer configured to be disposed on an upstream side in the flow path and form a mixed fluid including the three types of the raw materials fed from the liquid feeder;
a slug flow former configured to be disposed downstream of the mixer in the flow path;
an insoluble fluid introduction unit configured to introduce an insoluble fluid that is insoluble in the mixed fluid into the slug flow former; and
a controller,
wherein
the slug flow former merges the mixed fluid and the insoluble fluid so as to form a slug flow, and
the controller controls a flow rate of the mixed fluid to cause the mixed fluid to reach the slug flow former within a predetermined time from the mixer.

11. The apparatus according to claim 10, wherein the controller is configured to adjust a flow rate at which at least one of the one fluid or the other fluid is fed into the flow path.

12. The apparatus according to claim 10, wherein the controller is configured to adjust a flow rate at which the insoluble fluid is introduced into the slug flow former.

13. The apparatus according to claim 10, further comprising a heater disposed downstream of the slug flow former in the flow path.

14. The apparatus according to claim 10, wherein an inner wall of the flow path is composed of a material having low polarity.
